(19) United States
(12) Patent Application Publication
(10) Pub. No.: US 2015/0009095 A1
(43) Pub. Date: Jan. 8, 2015

(54) IMAGE DISPLAY SYSTEM AND ASSOCIATED METHOD

(71) Applicant: NOVATEK MICROELECTRONICS CORP., HsinChu (TW)

(72) Inventors: Kai-I DAI, Taoyuan County (TW); Jie-Jung HUANG, Miaoli County (TW)

(73) Assignee: NOVATEK MICROELECTRONICS CORP., HsinChu (TW)

(21) Appl. No.: 14/256,451

(22) Filed: Apr. 18, 2014

(30) Foreign Application Priority Data
Jul. 4, 2013 (TW) 102124023

(51) Int. Cl. G06F 3/14

(52) U.S. Cl. CPC G06F 3/1423
USPC 345/2.1

(57) ABSTRACT

An image display system includes a data output source, and receiving devices coupled to the data output source. The receiving devices decode a first packet header from the data output source to determine whether a first payload data associated with the first packet header is required by the receiving devices. Among the receiving devices, a first receiving device that requires the first payload data receives and displays the first payload data. Also among the receiving devices, a second receiving device that does not require the first payload data temporarily disables its data receiving function, and, before the data output source sends out a second packet header that the second receiving device requires, the second receiving device resumes its data receiving function and displays a second payload data.

This application claims the benefit of Taiwan application Serial No. 102124023, filed Jul. 4, 2013, the subject matter of which is incorporated herein by reference.

### TECHNICAL FIELD

The disclosure relates in general to an image display system and an associated method, and more particularly to an image display system capable of reducing power consumption and an associated method.

### BACKGROUND

Mobile devices (e.g., mobile phones and portable tablets) are indispensables in the daily life. Interfaces that can be applied to mobile devices come in overwhelming diversities and have different specifications, which is a challenge for mobile phone developers.

In hopes of solving the above problems, many developers and manufacturers have proposed common interface specifications, so as to reduce effort, time, costs and complications in designing mobile platforms.

The Mobile Industry Process Interface (MIPI) is a unified interface defined by certain leading mobile developers, and is aimed to allowing mobile developers to better focus on developing product differentiation rather than handling additional issues of interface specifications. Standards defined by the MIPI include a standard serial transmission bus MIPI D-PHY, which can be applied for image display in mobile phones.

It is a goal of developers and manufacturers to provide mobile devices with optimal performance (e.g., reduced power consumption) while meeting the MIPI specifications.

### SUMMARY OF THE DISCLOSURE

The disclosure is directed to an image display system and an associated method that achieves reduced power consumption through disabling a data receiving function of a data receiving device at appropriate time points while meeting the MIPI specifications.

According to an embodiment of the present disclosure, an image display system is provided. The image display system includes a data output source, and a plurality of receiving devices coupled to the data output source. The receiving devices decode a first packet header from the data output source to determine whether a first payload data associated with the first packet header is required by the receiving devices. Among the receiving devices, a first receiving device that requires the first payload data receives and displays the first payload data. Also among the receiving devices, a second receiving device that does not require the first payload data temporarily disables its data receiving function. Before the data output source sends out a second packet header that the second receiving device requires, the data receiving function of the second receiving device is resumed and the second receiving device receives and displays a second payload data.

According to another embodiment of the present disclosure, an image display system is provided. The image display method includes: decoding a first packet header from a data output source by a plurality of receiving devices to determine whether a first payload data associated with the first packet header is required by the plurality of receiving devices; receiving and displaying the first payload data by a first receiving device that requires the first payload data; temporarily disabling a data receiving function of a second receiving device that does not require the first payload data; before the data output source sends out a second packet header that is required by the second receiving device, resuming the data receiving function of the second receiving device; and receiving and displaying the second payload data by the second receiving device.

The above and other aspects of the disclosure will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image display system according to an embodiment of the present disclosure;

FIG. 2 is a timing diagram of display data outputted from a data output source to a plurality of receiving devices and a timing diagram of the receiving devices in FIG. 1;

FIG. 3 is a block diagram of an image display system according to another embodiment of the present disclosure; and

FIG. 4 is a timing diagram of display data outputted from a data output source to a plurality of receiving devices and a timing diagram of the receiving devices in FIG. 3.

### DETAILED DESCRIPTION OF THE DISCLOSURE

Technical terms of the application are based on general definition in the technical field of the application. If the application describes or explains one or some terms, definition of the terms are based on the description or explanation of the application. Further, shapes, sizes and ratios of the objects are exemplary for one skilled person in the art to understand the application, not to limit the application.

Each of the disclosed embodiments has one or more technical features. However, it does not mean that implementation of the application needs every technical feature of any embodiment of the application or combination of the embodiments of the application is prohibited. In other words, in possible implementation, one skilled person in the art would selectively implement part or all technical features of any embodiment of the application or selectively combine part or all technical features of the embodiments of the application based on the disclosure of the application and his/her own need. Implementation of the application is flexible.

Given individual elements in the embodiments are known elements, without affecting the full disclosure and possible implementation of the application, details for realizing the individual elements are omitted herein.

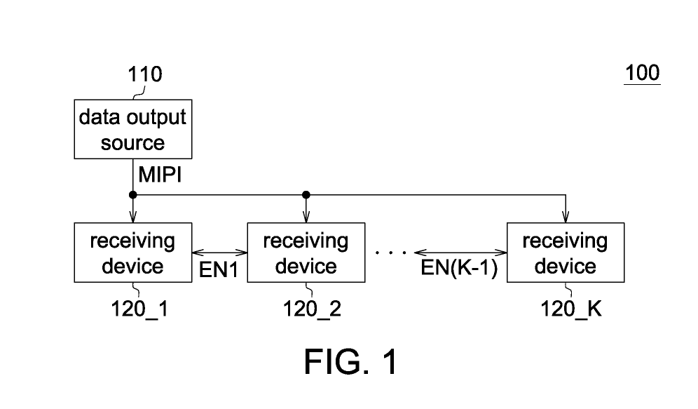

FIG. 1 shows a block diagram of an image display system according to an embodiment of the present disclosure. As shown in FIG. 1, an image display system 100 includes a data output source 110 and receiving devices 120_1 to 120_K, where K is a positive integer greater than 1. Further, enable pins EN1 to EN(K−1) may be selectively provided between every adjacent two of the receiving devices 120_1 to 120_K, respectively.

For example, the data output source 110 is an application program and/or a microprocessor. In the description below, the data output source 110 and the receiving devices 120_1 to 120K are mutually connected or coupled by a MIPI interface as an example for explaining the present disclosure.

For example, the receiving device is a high resolution display driver (e.g., a source driver) in a large-size mobile device which is more and more popular. To achieve high-resolution display, a large-size mobile device may include many receiving devices (source drivers), each of which receives and displays a part of display data.

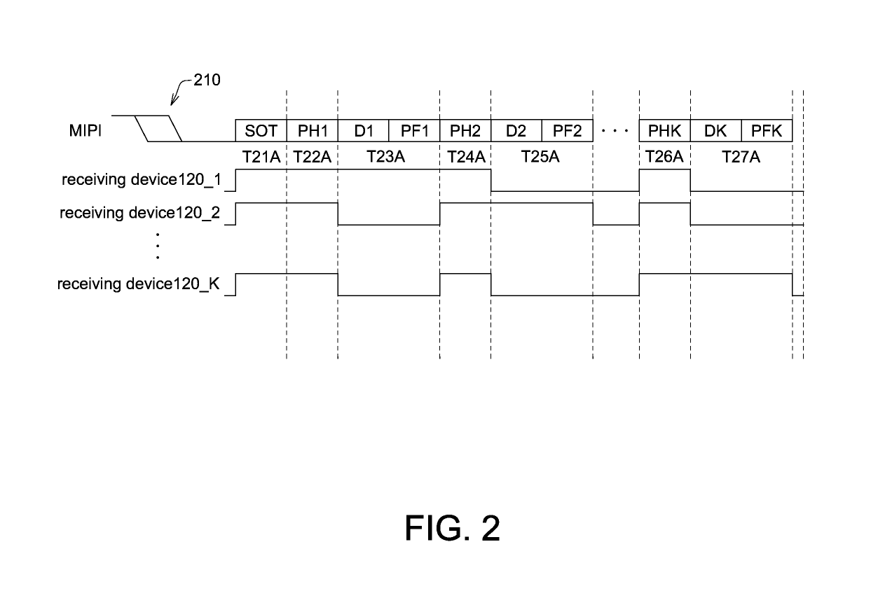

FIG. 2 shows a timing diagram of display data MIPI outputted from the data output source to the receiving devices and a timing diagram of the receiving devices in FIG. 1. In FIG. 2, the data output source 110 outputs an indication signal 210 to all of the receiving devices. The indication signal 210 may be a low-power, low-speed indication signal. According to the (low-power, low-speed) indication signal 210, the receiving devices determine whether to enter a high-speed transmission mode. Further, the (low-power, low-speed) indication signal 210 may also be used for resetting a current operation mode of the receiving devices.

In the embodiment, an example of how the receiving devices receive the display data MIPI are given below.

In the example, each receiving device decodes every packet header PH. When the decoded packet header is to be transmitted to a target receiving device, the target receiving device remains in a data receiving state or resumes to the data receiving state to receive a payload data or packet foot PF following the packet header PH.

Operations of the example are described below.

As shown in FIG. 2, the data output source 110 outputs a start of transition packet SOT to all of the receiving devices 120_1 to 120_K. Therefore, in FIG. 2, in the period T21A, all of the receiving devices 120_1 to 120K are in the data receiving state to receive the start of transition packet SOT.

In the period T22A, all of the receiving receives 120_1 to 120_K are in the data receiving state to receive and decode the packet header PH1. A packet header includes an identifier (ID), which is also referred to as a virtual channel (VC). After analyzing the identifier, the receiving device may determine whether a payload data associated with the packet header is required. In FIGS. 1 and 2, the identifiers of all of the receiving devices are different.

After decoding, the receiving device 120_1 determines that the payload data following the packet header PH1 is required, whereas the receiving devices 120_2 to 120_K determine that the payload data following the packet header PH1 is not required.

The payload data D1 is required by and to be displayed by the first receiving device 120_1. Thus, in the period T23A, the first receiving device 120_1 is in the data receiving state and receives the payload data D1 and the packet foot PF1. However, in the period T23A, the remaining receiving devices 120_2 to 120_K are in a data receiving suspended state (i.e., the data receiving function of the remaining receiving devices 120_2 to 120_K is temporarily disabled to reduce power consumption), and internal clocks of these receiving devices 120_2 to 120_K still count. In definition of the display data MIPI, lengths of the packet header, the payload data and the packet foot are predetermined. Therefore, after completely receiving the packet header PH1, the receiving devices 120_2 to 120_K may determine when the data output source 110 will send out the next packet header PH2 through counting, and can thus resume to the data receiving state at appropriate time points.

In the period T24A, the receiving device 120_1 is still in the data receiving state, and the receiving devices 120_2 to 120_K are resumed to the data receiving state. Thus, all of the receiving devices 120_1 to 120_K receive and decode the packet header PH2. Similarly, after decoding, the receiving device 120_2 determines that the payload data D2 following the packet header PH2 is required, whereas the remaining data receiving devices 120_1 and 120_3 to 120_K determine that the data D2 following the packet header PH2 is not required.

As the payload data D2 is required by the second receiving device 120_2, the second receiving device 120_2, in the data receiving state, receives the payload data D2 and the packet foot PF2 in the period T25A. However, in the period T25A, the remaining data receiving devices 120_1 and 120_3 to 120_K are in the data receiving suspended state to reduce power consumption, and the internal clocks of these data receiving devices 120_1 and 120_3 to 120_K still count.

Similarly, after completely receiving the packet header PH2, the data receiving devices 120_1 and 120_3 to 120_K determine when the data output source 110 will send out the next packet header PH3 through the internal timers, and can thus resume to the data receiving state at appropriate time points.

In the period T26A, the receiving device 120_(K−1) (not shown) is still in the data receiving state, and the receiving devices 120_1 to 120_(K−2) and 120_K are resumed to the data receiving state. Thus, all of the receiving devices 120_1 to 120_K receive and decode the packet header PHK. Similarly, after decoding, the receiving device 120_K determines that the payload data DK following the packet header PHK is required, whereas the remaining data receiving devices 120_1 to 120_(K−1) determine that the payload data DK following the packet header PHK is not required.

As the payload data DK is required by the K^{th} receiving device 120_K, the K^{th} receiving device 120_K, in the data receiving state, receives the payload data DK and the packet foot PFK in the period T26A. However, in the period T26A, the remaining data receiving devices 120_1 to 120_(K−1) are in the data receiving suspended state to reduce power consumption, and the internal clocks of these data receiving devices 120_1 to 120_(K−1) still count.

It is known from the above description, in the example of the embodiment of the present disclosure, through appropriately disabling the data receiving function of the receiving devices that are not responsible for display, power consumption is reduced without affecting the image display function of the receiving devices.

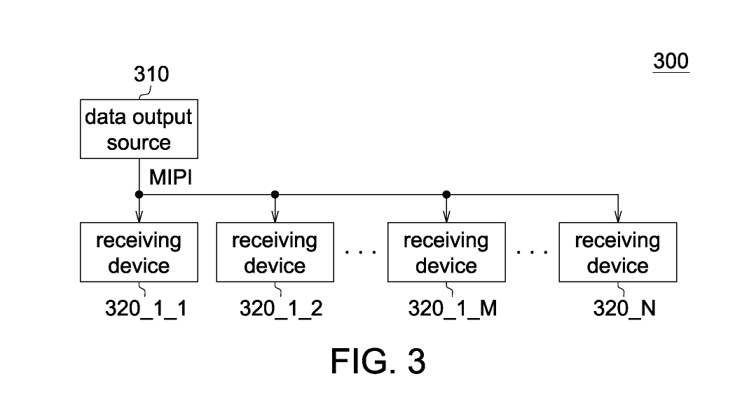

FIG. 3 shows a block diagram of an image display system according to another embodiment of the present disclosure. Different from FIG. 1, identifiers of receiving devices 310_1_1 to 320_1_M (where M is a positive integer) in FIG. 3 are the same but different from those of the remaining receiving devices.

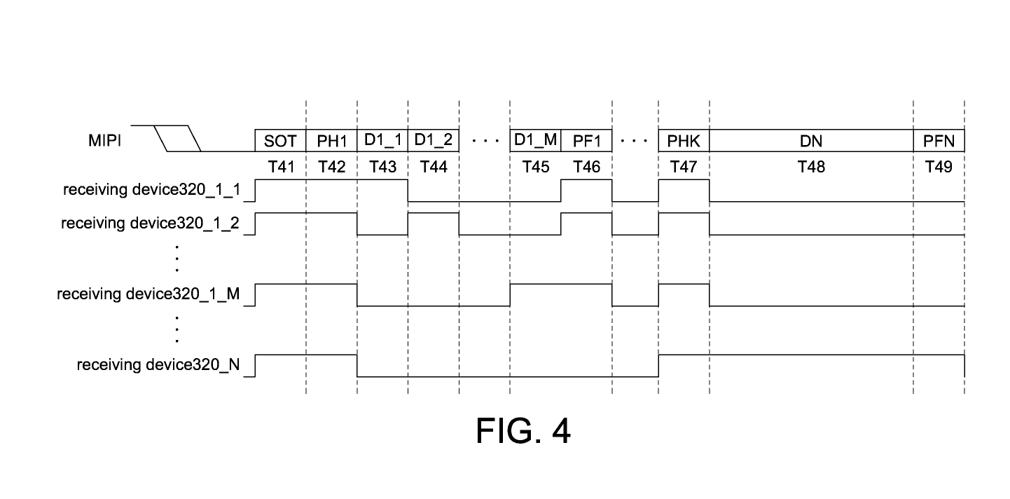

FIG. 4 shows a timing diagram of display data MIPI outputted from a data output source to receiving devices and a timing diagram of the receiving devices in FIG. 3.

In the period T41, the data output source 310 outputs a start of transition packet SOT to all of the receiving devices 320_1_1 to 320_N (where N is a positive integer). Thus, in the period T41, all of the receiving devices 320_1_1 to 320_N are in the data receiving state and receive the start of transition packet SOT. M and N are independent numbers.

In the period T42, all of the receiving devices 320_1_1 to 320_N are in the data receiving state, and receive and decode the packet header PH1. After decoding, the receiving devices 320_1_1 to 320_1_M determine that the payload data following the packet header PH1 is required. The payload data is divided into multiple parts and each of the receiving devices 320_1_1 to 320_1_M requires one part of the payload data. Also after decoding, the receiving device 320_2 (not shown) to 320_N determine that the payload data following the packet header PH1 is not required.

After analyzing the packet header PH1, the receiving device 320_1_1 determines that the payload data D1_{—}1, which is required by the receiving device 320_1_1, follows the packet header PH1. Thus, in the period T43, the receiving device 320_1_1 receives the payload data D1_{—}1, whereas the remaining receiving devices 320_1_2 to 320_1_M and 320_2 to 320_N are in the data receiving suspended state.

After analyzing the packet header PH1, the receiving device 320_1_2 determines that the payload data D1_{—}2, which is required by the receiving device 320_1_2, follows the payload data D1_{—}1. Thus, in the period T44, the receiving device 320_1_2 receives the payload data D1_{—}1, whereas the remaining receiving devices 320_1_1, 320_1_3 to 320_1_M and 320_2 to 320_N are in the data receiving suspended state.

In FIG. 3, details for resuming the receiving devices in the data receiving suspended state to the data receiving state at appropriate time points may be referred from the description associated with FIG. 2, and shall be omitted herein. The example in FIG. 2 is utilized for illustrating the embodiment, not limiting the present disclosure.

Similarly, after analyzing the packet header PH1, the receiving device 320_1_M determines that the required payload data D1_M follows the payload data D1_(M−1) (not shown). Thus, in the period T45, the receiving device 320_1_M receives the payload data D1_M, whereas the remaining receiving devices 320_1_1 to 320_1_(M−1) and 320_2 to 320_N are in the data receiving suspended state.

In the period T46, the receiving devices 320_1_1 to 320_1_M are in the data receiving devices and receive the packet foot PF1.

In the period T47, all of the timing devices 320_1_1 to 320_N are in the data receiving state, and receive and decode the packet header PHN. After decoding, the receiving device 320_N determines that the payload data following the packet header PHN is required, whereas the receiving devices 320_1_1 to 320_(N−1) determine that the payload data following the packet header PHN is not required.

In the periods T48 and T49, the receiving device 320_N receives the payload data DN and the packet foot PFN, whereas the remaining receiving devices 320_1_1 to 320_1_M and 320_2 to 320_(N−1) are in the data receiving suspended state.

In the image display system in FIG. 3, the receiving devices 320_1_1 to 320_1_M share the same identifier (e.g., ID1). In other possible embodiments of the present disclosure, receiving devices (other than the receiving devices 320_1_1 to 320_1_M) may share another identifier (e.g., ID2). Alternatively, receiving devices (other than the receiving devices sharing ID1 and ID2) may share another identifier (e.g., ID3).

In the two above embodiments, by detecting a packet header, a receiving device determines whether data is required. If data is not required, the data receiving function of the receiving device is disabled. The data receiving function of the receiving device is resumed when the receiving device is enabled or when the receiving device determines that the required packet header or the required payload data is to be coming. As such, power consumption is reduced without affecting the image display function.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image display system, comprising:
a data output source; and
a plurality of data receiving devices, coupled to the data output source;
wherein, the receiving devices decode a first packet header from the data output source to determine whether a first payload data associated with the first packet header is required by the receiving devices;
a first receiving device that requires the first payload data receives and displays the first payload data; and
among the receiving devices, a second receiving device that does not require the first payload data temporarily disables a data receiving function thereof;
before the data output source sends out a second packet header that the second receiving device requires, the data receiving function of the second receiving device is resumed and the second receiving device receives and displays a second payload data.

2. The image display system according to claim 1, wherein the data output source and the receiving devices are coupled by a Mobile Industry Process Interface (MIPI) interface.

3. The image display system according to claim 1, wherein the data output source comprises an application program and/or a microprocessor, and the receiving device comprises a source driver.

4. The image display system according to claim 1, wherein the data output source outputs an indication signal to the receiving devices, and the receiving devices accordingly determine operation modes or whether to reset.

5. The image display system according to claim 1, wherein:
the data output source outputs a start of transition packet to the receiving devices;
the receiving devices receive and decode the first packet header, the first packet header comprises an identifier, the receiving devices analyze the identifier to determine whether the first payload data is required by the receiving devices, the receiving devices having different identifiers; and
when the first receiving device requires the first payload data, among the receiving devices, the remaining receiving devices that do not require the first payload data temporarily disable the data receiving function and continue internal counting in order to resume the data receiving function before the data output source sends out the second packet header, and the receiving devices decode the second packet header.

6. The image display system according to claim 1, wherein:
the data output source outputs a start of transition packet to the receiving devices;
the receiving devices receive and decode the first packet header, the first packet header comprises an identifier, the receiving devices analyze the identifier to determine whether the first payload data is required by the receiving devices, the receiving devices having different identifiers;
among the receiving devices, the remaining receiving devices that do not require the first payload data temporarily disable the data receiving function and continue internal counting; and
before the data output source sends out the second packet header, the second receiving device among the receiving devices resumes the data receiving function and receives and decodes the second packet header, and the remaining receiving devices other than the second receiving device temporarily disable the data receiving function and continue internal counting.

7. The image display system according to claim 1, wherein:
the data output source outputs a start of transition packet to the receiving devices;
the receiving devices receive and decode the first packet header, the first packet header comprises an identifier, the receiving devices analyze the identifier to determine whether the first payload data is required by the receiving devices, the receiving devices having different identifiers;
among the receiving devices, the remaining receiving devices that do not require the first payload data temporarily disable the data receiving function; and
before the data output source sends out the second packet header, the first receiving device enables the second receiving device to resume the data receiving function of the second receiving device, and accordingly the second receiving device receives and decodes the second packet header, and the remaining receiving devices other than the second receiving device temporarily disable the data receiving function.

8. The image display system according to claim 1, wherein:
a third receiving device and a fourth receiving device among the receiving devices share a first identifier;
after the third receiving device and the fourth receiving device sharing the first identifier receive a third packet header comprising the first identifier, the third receiving device receives and displays a first part of a third payload data and the fourth receiving device temporarily disables the data receiving function; and
the fourth receiving device resumes the data receiving function to receive and display a second part of the third payload data, and the third receiving device temporarily disables the data receiving function.

9. An image display method, comprising:
decoding a first packet header from a data output source by a plurality of receiving devices to determine whether a first payload data associated with the first packet header is required by the plurality of receiving devices;
receiving and displaying the first payload data by a first receiving device that requires the first payload data;
temporarily disabling a data receiving function of a second receiving device among the receiving devices that does not require the first payload data;
resuming the data receiving function of the second receiving device before the data output source sends out a second packet header that is required by the second receiving device; and
receiving and displaying a second payload data by the second receiving device.

10. The image display method according to claim 9, wherein the data output source and the receiving devices are coupled by a MIPI interface.

11. The image display method according to claim 9, wherein the data output source comprises an application program and/or a microprocessor, and the receiving device comprises a source driver.

12. The image display method according to claim 9, wherein the data output source outputs an indication signal to the receiving devices, and the receiving devices accordingly determine operation modes or whether to reset.

13. The image display method according to claim 9, wherein:
the data output source outputs a start of transition packet to the receiving devices;
the receiving devices receive and decode the first packet header, the first packet header comprises an identifier, the receiving devices analyze the identifier to determine whether the first payload data is required by the receiving devices, the receiving devices having different identifiers; and
when the first receiving device requires the first payload data, among the receiving devices, the remaining receiving devices that do not require the first payload data temporarily disable the data receiving function and continue internal counting in order to resume the data receiving function before the data output source sends out the second packet header, and the receiving devices decode the second packet header.

14. The image display method according to claim 9, wherein:
the data output source outputs a start of transition packet to the receiving devices;
the receiving devices receive and decode the first packet header, the first packet header comprises an identifier, the receiving devices analyze the identifier to determine whether the first payload data is required by the receiving devices, the receiving devices having different identifiers;
among the receiving devices, the remaining receiving devices that do not require the first payload data temporarily disable the data receiving function and continue internal counting; and
before the data output source sends out the second packet header, the second receiving device among the receiving devices resumes the data receiving function and receives and decodes the second packet header, and the remaining receiving devices other than the second receiving device temporarily disable the data receiving function and continue internal counting.

15. The image display method according to claim 9, wherein:
the data output source outputs a start of transition packet to the receiving devices;
the receiving devices receive and decode the first packet header, the first packet header comprises an identifier, the receiving devices analyze the identifier to determine whether the first payload data is required by the receiving devices, the receiving devices having different identifiers;
among the receiving devices, the remaining receiving devices that do not require the first payload data temporarily disable the data receiving function; and
before the data output source sends out the second packet header, the first receiving device enables the second receiving device to resume the data receiving function of the second receiving device and accordingly the second receiving device receives and decodes the second packet header, and the remaining receiving devices other than the second receiving device temporarily disable the data receiving function.

16. The image display method according to claim 9, wherein:
a third receiving device and a fourth receiving device among the receiving devices share a first identifier;
after the third receiving device and the fourth receiving device sharing the first identifier receive a third packet header comprising the first identifier, the third receiving device receives and displays a first part of a third payload data and the fourth receiving device temporarily disables the data receiving function; and
the fourth receiving device resumes the data receiving function to receive and display a second part of the third payload data, and the third receiving device temporarily disables the data receiving function.
